(19) United States
(12) Patent Application Publication
(10) Pub. No.: US 2005/0259803 A1
(43) Pub. Date: Nov. 24, 2005

(54) Managing a conference session

(75) Inventor: Hisham Khartabil, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/991,730

(22) Filed: Nov. 19, 2004

Related U.S. Application Data
(60) Provisional application No. 60/572,442, filed on May 19, 2004.

(51) Int. Cl. H04M 3/42; G06F 15/16

(52) U.S. Cl. 379/202.01; 709/204

(57) ABSTRACT

A method provides managing a conference session in a communication system. The method includes maintaining a main conference between at least three communicating parties over a shared floor. The method also includes creating a sidebar to the main conference. Parties of the sidebar include at least the main conference and at least two of the at least three communicating parties. Furthermore, a managing entity for a communication system, a communication system and a communication device are configured to execute the method.

This application relies on U.S. Provisional Patent Application Ser. No. 60/572,442, filed on 19 May 2004 and entitled “Sidebar to a conference”, which is hereby incorporated by reference.

### FIELD OF THE INVENTION

The invention relates to communication systems, and more particularly to conference sessions. In particular, the invention relates to managing a conference session in a communication system.

### BACKGROUND OF THE INVENTION

A communication system can be seen as a facility that enables communication sessions between two or more entities such as user terminal and/or other nodes associated with the communication system. Subscribers, such as the users or end-users, to a communication system may be offered and provided numerous services, such as calls, data communication or multimedia services or simply an access to a network, such as the Internet. The services may be offered by an operator of the communication system or by an external service provider.

Examples of communication systems may include, but are not limited to, fixed line communication systems, such as a public switched telephone network (PSTN), wireless communication systems, such as a public land mobile network (PLMN), e.g. global system for mobile communications (GSM), general packet radio service (GPRS), universal mobile telecommunications system (UMTS), other wireless systems, such as a wireless local area network (WLAN), and/or other communication networks, such as an Internet Protocol (IP) network and/or other packet switched data networks. Various communication systems may simultaneously be concerned in a connection.

A conference may be defined as a unique instance of a multiparty conversation over a shared resource, also called a shared floor. A sidebar of a conference may appear to the users within the sidebar as a sub-conference. The sidebar is a conversation amongst a subset of the participants to which the remaining participants of the main conference are not privy.

A sidebar is defined as just another conference. Therefore, there may be a problem of how to relate the main conference to the sidebar. Relating the sidebar to the main conference may be needed in order to ameliorate usability of the sidebar and for improving the managing characteristics of the sidebar.

### SUMMARY OF THE INVENTION

In accordance with an aspect of the invention, there is provided a method for managing a conference session in a communication system. The method comprises maintaining a main conference between at least three communicating parties over a shared floor. The method further comprises creating a sidebar to the main conference, parties of the sidebar comprising at least the main conference and at least two of the at least three communicating parties.

In an embodiment, a sidebar request may carry at least an indication of the parties of the sidebar.

In an embodiment, a sidebar focus may be created, the sidebar focus inviting the parties of the sidebar to join the sidebar.

In an embodiment, a sidebar focus may be created, the sidebar focus referring a main conference focus to the sidebar, the main conference focus inviting the parties of the sidebar to join the sidebar.

In an embodiment, the sidebar request may further carry a sidebar policy. The sidebar policy may be applied between the main conference and the sidebar. In an embodiment, a lower volume may be applied for the main conference than for the sidebar.

In an embodiment, an invitation may be transmitted to the parties of the sidebar to join the sidebar transmitting from one of the at least three communicating parties.

In an embodiment, one of the at least three communicating parties may refer the parties of the sidebar to join the sidebar.

In accordance with another aspect of the invention, there is provided a computer program embodied on a computer-readable medium, said computer program configured to control a computer to perform the steps of maintaining a main conference between at least three communicating parties over a shared floor, and creating a sidebar to the main conference, parties of the sidebar comprising at least the main conference and at least two of the at least three communicating parties.

In accordance with another aspect of the invention, there is provided a managing entity for a communication system. The managing entity comprises conference means for maintaining a main conference between at least three communicating parties over a shared floor. The managing entity further comprises sidebar creating means for creating a sidebar to the main conference, parties of the sidebar comprising at least the main conference and at least two of the at least three communicating parties.

In accordance with another aspect of the invention, there is provided a managing entity for a communication system. The managing entity is configured to maintain a main conference between at least three communicating parties over a shared floor. The managing entity is further configured to create a sidebar to the main conference, parties of the sidebar comprising at least the main conference and at least two of the at least three communicating parties.

In an embodiment, the managing entity may comprise one of a multiparty conferencing server, a push-to-talk over cellular server and a communicating party of the main conference.

In accordance with another aspect of the invention, there is provided a communication system comprising conference means for maintaining a main conference between at least three communicating parties over a shared floor and sidebar creating means for creating a sidebar to the main conference, parties of the sidebar comprising at least the main conference and at least two of the at least three communicating parties.

In accordance with another aspect of the invention, there is provided a communication system configured to maintain a main conference between at least three communicating parties over a shared floor and to create a sidebar to the main conference, parties of the sidebar comprising at least the main conference and at least two of the at least three communicating parties.

In accordance with another aspect of the invention, there is provided a communication device configured to participate in a main conference between the communication device and at least two other communicating parties over a shared floor. The communication device is further configured to initiate creation of a sidebar to the main conference, parties of the sidebar comprising at least the main conference and at least one of the at least two other communicating parties.

In an embodiment, the communication device may be further configured to invite the parties of the sidebar to join the sidebar.

In an embodiment, the communication device may be further configured to refer the parties of the sidebar to join the sidebar.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented; and

FIG. 2 shows a signaling chart illustrating an embodiment of the invention.

### DETAILED DESCRIPTION OF PREFERRED EMBODIMENTS

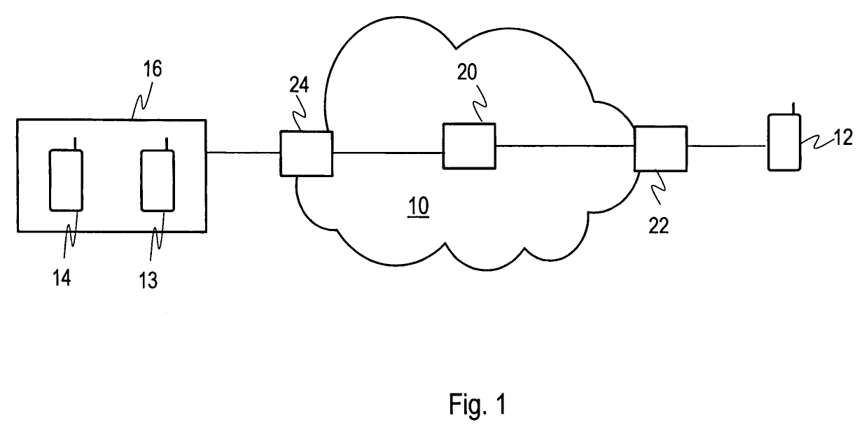

FIG. 1 shows an example of an arrangement including a communication network 10, a first communication device 12, a second communication device 13 and a third communication device 14. The communication devices 13 and 14 are shown to form a group 16. The first communication device 12 is shown to access the communication network 10 via an access entity 22. The first communication device 12 may, for example, wirelessly transmit and receive radio signals via a radio interface to and from a transceiver network element connected to the access entity 22. Correspondingly, the transceiver network element may wirelessly transmit and receive radio signals to and from the first communication device 12. Furthermore, the second communication device 13 and the third communication device 14 are shown to access the communication network 10 via the access entity 24.

A conference server 20, managing a conference between the communication devices 12, 13, 14, is also shown. The conference server 20 may manage access to a shared resource and may relate to a floor chair or a floor moderator. Operation of the exemplifying conference server shall become clear from the following examples of embodiments of the invention.

It shall be appreciated that FIG. 1 is only an example showing only three communication devices. Typically, a plurality of communication devices is simultaneously communicating via a communication network. Furthermore, a communication device may have several simultaneous communication sessions, for example a number of SIP sessions and activated packet data protocol (PDP) contexts. The communication devices may be connected to the communication system from the same or different networks. The communication devices may access the communication network 10 via any appropriate access system. Examples may include, but are not limited to, radio access networks, e.g. an UMTS terrestrial radio access network (UTRAN) or a GSM/EDGE radio access network (GERAN), and short-range wireless systems, such as the Bluetooth, and so on. The communication network 10 may comprise any appropriate communication network or networks. In an embodiment, the communication network 10 is provided at least in part by the Internet protocol Multimedia Subsystem (IMS).

Names of the entities in a communication system depend on the system. For example, access entities of radio access networks may comprise a controller, such as a radio network controller (RNC) in 3GPP (Third Generation Partnership Project) systems and base station controller (BSC) in 3GPP2 (Third Generation Partnership Project 2) systems. Furthermore, even if omitted from FIG. 1, a communication system typically comprises various further switching and other control entities and gateways for enabling the communication via a number of radio access networks and also for interfacing a single communication system with one or more communication systems, such as with other cellular systems and/or fixed line communication systems. Several transceiver network elements, in other words transmitter/receivers, such as Node B in 3GPP, BTS (base transceiver station) in 3GPP2, may be included in a single radio access network.

An end-user may access a communication network by means of any appropriate communication device, such as user equipment (UE), a mobile station (MS), a cellular phone, a personal digital assistant (PDA) or the like, or other devices, such as a personal computer (PC), or any other equipment operable according to a suitable network protocol, such as a Session Initiation Protocol (SIP), a wireless applications protocol (WAP) or a hypertext transfer protocol (HTTP). A communication device may be provided with an antenna or other such transceiver and receiver means for wirelessly receiving and transmitting signals from and to a transceiver network element of a wireless communication system. A communication device may also be provided with a display and a speaker. The operation of a communication device may be controlled by means of a suitable user interface comprising control means, such as a keypad, voice commands, touch sensitive screen or pad, or combinations thereof, or the like. The user interface may display a user a menu, a list or the like and allow the end-user to select an option from the menu. The end-user may indicate the selection by using the control means. The user interface may detect user activity and communicate the selection to a communicating logic of the communication device. A communication device is typically provided with a processor and memory means as well as software and applications operating the device and enabling operation with other entities. Software, which is able to request services from other entities in a communication system, may be called a client.

A communication system, for example the IMS, may support the session initiation protocol (SIP) as developed by the Internet engineering task force (IETF), see e.g. IETF RFC 3261 “SIP: Session Initiation Protocol”. The SIP is an application layer control protocol for creating, modifying and terminating sessions with one or more participants, i.e. end-points. A user connected to a SIP base communication system may communicate with various entities of the communication system based on standardized SIP messages. Communication devices or users who run certain applications on the communication devices are registered with the SIP backbone so that an invitation to a particular session can be correctly delivered to these end points. The SIP provides a registration mechanism for devices and users and applies mechanisms such as location servers and registrars to route the session invitations appropriately. The SIP allows establishment, handling and release of end-to-end multimedia sessions, for example Internet telephony calls or multicast conferences. A conference may be defined as a unique instance of a multi-party conversation. Additions to the SIP allowing conferencing have been defined. A SIP conferencing framework defines mechanisms for multi-party centralized conferencing in a SIP environment. Existing SIP mechanisms allow users, for example, to join and leave a conference.

Uniform Resource Identifiers (URIs) are used to identify different types of actors in a SIP-controlled network. Typically a URI points to a registered user identity of an individual user. A URI may identify also services, such as voicemail server or conference factory URI, conferencing instances, such as chat rooms or voice-over-IP (VoIP) conferencing instances, or other types of resources. In addition, a URI may point to a resource list, which may be a list of individual URIs, or in other words, a group of URIs. Resource lists may be used in many applications, such as for one-to-many messaging, and so on. For example, a server in a network may maintain resource lists of e.g. one operator. A request addressed to such a resource list may be routed to the server, which may forward the request to individual contacts behind the resource list.

In this specification, terms user, end-user, user agent, subscriber and resource all refer to an entity able to use services via a communication network. A user or user agent is typically an individual registered user identity. Term end-user may be used to denote a human user of the system. A subscriber or resource may refer to an individual user or to a group of users subscribing a single subscription. Terms resource list and group define herein an entity having an own identifier, such as an own URI, and comprising a number of entities each having a different identifier, such as a different URI.

Embodiments of the invention may be implemented, for example, in multiparty conferencing services, such as PoC services. A PoC system may be integrated within a cellular telecommunication system and may be implemented using push-to-talk servers in the IMS. The PoC service is based on multi-unicasting. Each transmitting communication device may send packet data traffic to a dedicated push-to-talk server. In case of a group call, the server may duplicate or multiply the traffic to be received by all recipients. Principles of the invention may be implemented also in other multiparty conferencing services.

A conference, for example the PoC, can be created in various ways. For example, the SIP or the Conference Policy Control Protocol (CPCP) may be used. The CPCP is discussed, for example, in Khartabil et al by IETF, The Conference Policy Control Protocol (CPCP), draft-ietf-xcon-cpcp-00 September 2004. Voice and data control traffic may be carried through a real time protocol (RTP) streaming bearer. The RTP is defined in IETF RFC 3550 “RTP: A Transport Protocol for Real-Time Applications”. The RTP provides end-to-end delivery services for data with real-time characteristics, such as interactive audio and video, and supports data transfer to multiple destinations using multicast distribution if provided by the underlying network. Conferences are not limited to audio and video, but also to text and any other media

A conference focus is a SIP user agent that is addressed by a conference URI and identifies a conference. The conference focus maintains a SIP signaling relationship with each participant in the conference. The conference focus is responsible for ensuring, in some way, that each participant receives the media that make up the conference. The conference focus also implements conference policies. The focus is a logical role. The focus may, for example, invite users to join a conference. A conference server is a physical entity managing a conference. The conference server contains, at a minimum, the conference focus. The conference server may also include a conference policy server and mixers.

A conference policy is defined as a complete or overall set of rules governing operation of a conference. A logical function called a conference policy server may store and manipulate the conference policy. The conference policy includes a membership policy and a media policy. Unlike the focus, there is not an instance of the conference policy server for each conference. Rather, there is an instance of the membership and media policies for each conference.

In the conference policy, there may be a Dial-out list (DL) that lists the users that a conference focus invites into the conference at a specified time. The conference policy may also contain authorization rules that allow users to join or deny users from joining a conference. The conference policy may also allow a creator of a conference to indicate to the conference focus the users that the creator would like the conference focus to refer to the conference when the conference starts. The focus may then send a SIP REFER request to those users referring them to the conference.

A conference state event package using a SIP event notification framework (SUBSCRIBE/NOTIFY) is available for participants of a conference to learn, amongst other things, the current participants of the conference.

As mentioned above, a sidebar is thought of as a separate conference with an own conference URI pointing to the sidebar. It has now been found that a user creating a sidebar may include the main conference as a participant. This may ameliorate usability of the sidebar and improve the managing characteristics of the sidebar. An example may comprise that audio of the main conference can appear in the sidebar in the background with a lower volume than the conversation that is taking place in the sidebar. Another example may comprise that only the current participants in the main conference are allowed to join or be invited into a sidebar.

In an embodiment, this may be achieved by adding the main conference URI to the dial-out list or to the list of potential participants to be referred. The sidebar focus may then dial out, i.e. invite, the main conference into the sidebar. In dialing out, the sidebar focus initiates a session establishment process with the main conference focus by sending a SIP INVITE request. In an alternative, the sidebar may refer to the main conference. In referring, the sidebar focus refers the main conference focus to the sidebar by sending a SIP REFER request. The main conference focus then needs to initiate the session establishment process towards the sidebar. In this case, it is the main conference focus that sends the SIP INVITE request.

Media policy or sidebar policy, being a part of a conference policy, may indicate conditions to be fulfilled in a relationship between the sidebar and the main conference. The media policy may, for example, define that audio of the main conference has a lower volume than the sidebar. The sidebar participants are then able to hear the main conference in the background, but have a higher volume for the sidebar itself.

The main conference focus may learn that there is a sidebar to the main conference, because the main conference is invited to join the sidebar. Depending of the conference policy, the focus of the main conference may accept invitations or refers to join a sidebar after the main conference focus has examined a participant list, such as a dial-out list or authorization rules indicating the users who can dial into the sidebar, of the sidebar and concluded that all the sidebar participants and a creator requesting the creation of the sidebar are participants of the main conference. The main conference focus can also learn the participant list of the sidebar by subscribing to a conference state event package.

In an embodiment, a sidebar may be created in an ad hoc manner. This means that no conference policy is created. In this embodiment, a user creating a sidebar, also called a creator of the sidebar, may directly refer or invite other users to join the sidebar, using the SIP or other protocol means. The creator may also refer the main conference to the sidebar or include the main conference in the invitations the creator sent to participants to join the sidebar. The main conference focus may learn that there is a sidebar to the main conference because the main conference was invited to join the sidebar. Depending of the conference policy, the main conference focus may accept invitations or refers to join a sidebar after the main conference focus has examined the participant lists of the sidebar and concluded that all sidebar participants and the creator are participants of the main conference.

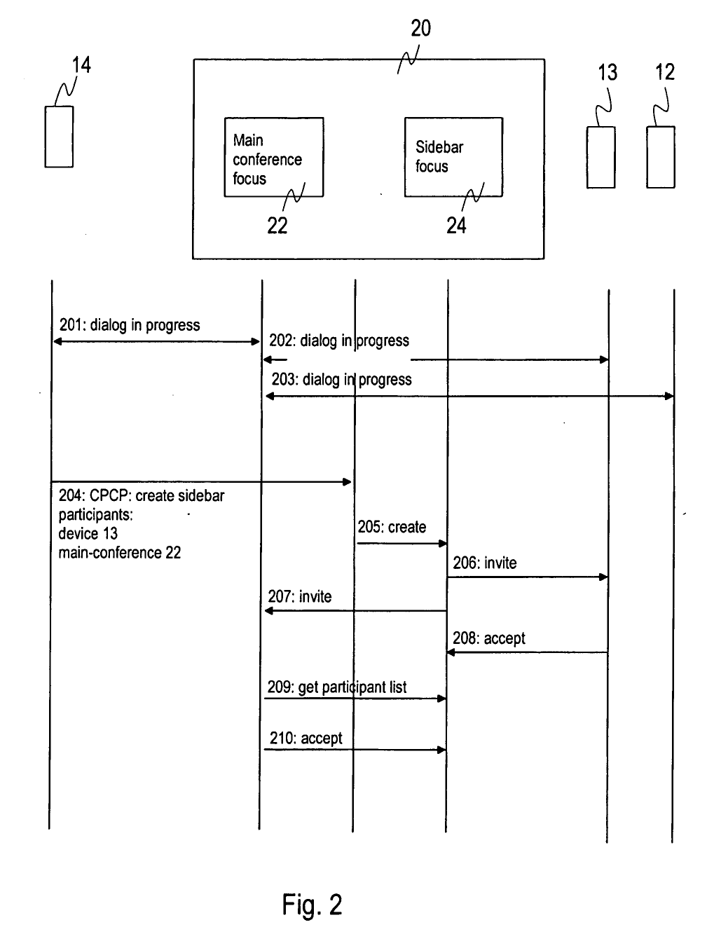

FIG. 2 illustrates signaling relating to an exemplifying embodiment of the invention. Reference is made also to the entities showed in FIG. 1. The conference server 20 manages a main conference between communication devices 12, 13, 14. In the conference server, a main conference focus 22 and a sidebar focus 24 are shown.

The main conference focus 22 maintains the signaling relationship (signals 201, 202, 203) with each participant of the main conference, namely with each of the communication devices 12, 13, 14.

In signal 204, the communication device 14 transmits a CPCP signal to the conference server 20 for requesting to create a sidebar. This signal 204 carries the sidebar policy and names sidebar participants comprising the communication device 13 and the main conference.

The conference server, after receiving the signal 204, creates the sidebar focus 24 (signal 205). The sidebar focus 24 learns about the participants that need to be invited into the sidebar by viewing the sidebar policy. The sidebar focus 24 invites (signal 206) the communication device 13 to join the sidebar. The sidebar focus 24 invites (signal 207) also the main conference focus 22 to join the sidebar.

The communication device 13 informs the sidebar focus 24 that the communication device 13 accepts joining the sidebar (signal 208).

The main conference focus 22 requests (signal 209) participant information, such as a participant list, of the sidebar. When the main conference focus 22 concludes that all sidebar participants 13, 22 and creator, namely the communication device 14, are in fact participants of the main conference, the main conference focus accepts joining the sidebar (signal 210).

Although the invention has been described in the context of particular embodiments, various modifications are possible without departing from the scope and spirit of the invention as defined by the appended claims. It should be appreciated that whilst embodiments of the present invention have mainly been described in relation to mobile communication devices, such as mobile user equipment, embodiments of the present invention may be applicable to other types of communication devices that may access communication networks and participate in group communication over a shared resource. Furthermore, the communication system may be any appropriate communication system providing group communication over a shared resource, even if reference has mainly been made to mobile communication systems.

1. A method for managing a conference session in a communication system, the method comprising:
maintaining a main conference between at least three communicating parties over a shared floor; and
creating a sidebar to the main conference, wherein parties of the sidebar include at least the main conference and at least two of the at least three communicating parties.

2. A method according to claim 1, wherein the step of creating comprises receiving a sidebar request carrying at least an indication of the parties of the sidebar.

3. A method according to claim 2, wherein the step of creating comprises creating a sidebar focus, the sidebar focus inviting the parties of the sidebar to join the sidebar.

4. A method according to claim 2, wherein the step of creating the sidebar comprises creating a sidebar focus, the sidebar focus referring a main conference focus to the sidebar, wherein the main conference focus invites the parties of the sidebar to join the sidebar.

5. A method according to claim 2, wherein the step of receiving comprises receiving the sidebar request carrying a sidebar policy.

6. A method according to claim 5, wherein the step of creating comprises applying the sidebar policy between the main conference and the sidebar.

7. A method according to claim 6, wherein the step of applying the sidebar policy comprises applying a lower volume for the main conference than for the sidebar.

8. A method according to claim 1, wherein the step of creating comprises transmitting an invitation to the parties of the sidebar to join the sidebar from one of the at least three communicating parties.

9. A method according to claim 1, wherein the step of creating comprises referring, by one of the at least three communicating parties, the parties of the sidebar to join the sidebar.

10. A computer program embodied on a computer-readable medium, said computer program configured to control a computer to perform the steps of:
maintaining a main conference between at least three communicating parties over a shared floor;
creating a sidebar to the main conference, wherein parties of the sidebar include at least the main conference and at least two of the at least three communicating parties.

11. A managing entity for a communication system, comprising:
conference means for maintaining a main conference between at least three communicating parties over a shared floor; and
sidebar creating means for creating a sidebar to the main conference, wherein parties of the sidebar include at least the main conference and at least two of the at least three communicating parties.

12. A managing entity for a communication system, configured to:
maintain a main conference between at, least three communicating parties over a shared floor; and
create a sidebar to the main conference, wherein parties of the sidebar include at least the main conference and at least two of the at least three communicating parties.

13. A managing entity according to claim 12, comprising one of a multiparty conferencing server, a push-to-talk over cellular server and a communicating party of the main conference.

14. A communication system comprising:
conference means for maintaining a main conference between at least three communicating parties over a shared floor; and
sidebar creating means for creating a sidebar to the main conference, wherein parties of the sidebar include at least the main conference and at least two of the at least three communicating parties.

15. A communication system configured to:
maintain a main conference between at least three communicating parties over a shared floor; and
create a sidebar to the main conference, wherein parties of the sidebar include at least the main conference and at least two of the at least three communicating parties.

16. A communication device configured to:
participate in a main conference between the communication device and at least two other communicating parties over a shared floor; and
initiate creation of a sidebar to the main conference, wherein parties of the sidebar include at least the main conference and at least one of the at least two other communicating parties.

17. A communication device according to claim 16, configured to invite the parties of the sidebar to join the sidebar.

18. A communication device according to claim 16, configured to refer the parties of the sidebar to join the sidebar.
